(19) United States
(12) Patent Application Publication
(10) Pub. No.: US 2026/0061690 A1
(43) Pub. Date: Mar. 5, 2026

(54) HEATING SYSTEM FOR HEATING PLASTIC MATERIAL PREFORMS

(71) Applicant: S.I.P.A. SOCIETA' INDUSTRIALIZZAZIONE PROGETTAZIONE E AUTOMAZIONE S.P.A., Vittorio Veneto (IT)

(72) Inventors: Silvio DA LOZZO, Vittorio Veneto (IT); Paolo DE NARDI, Treviso (IT); Matteo ZOPPAS, Conegliano (IT)

(21) Appl. No.: 19/107,247

(22) PCT Filed: Sep. 1, 2023
(86) PCT No.: PCT/IB2023/058669

§ 371 Date: Feb. 27, 2025

(30) Foreign Application Priority Data
Sep. 2, 2022 (IT) 102022000018042

(51) Int. Cl. B29C 49/78; B29B 13/02; B29C 35/08; B29C 49/02; B29C 49/08; B29C 49/64; B29C 49/68; B29L 31/00

(52) U.S. Cl. CPC B29C 49/786; B29B 13/024; B29C 35/0805; B29C 49/02; B29C 49/08; B29C 49/6418; B29C 49/6452; B29C 49/6845; B29C 2035/0822; B29C 2035/0838; B29C 2049/024; B29C 2049/7861; B29C 2049/78805; B29C 2949/0715; B29L 2031/7158

(57) ABSTRACT

A heating system (2) for heating plastic material preforms upstream of a blow molding or stretch-blow molding machine (3), the system comprising a heating module (4) adapted to be crossed by a plurality of preforms (5) advancing along a transport line (14),
wherein the heating module (4) is provided with a plurality of heating elements (12, 13) arranged along a plane substantially parallel to a plane containing the axes of the preforms adapted to cross said heating module,
wherein the heating module (4) comprises a first heating zone (10), proximal to a support area of the neck of the preforms and comprising at least one first heating element (12) of said plurality of heating elements, and at least one second heating zone (11), arranged adjacent to said first heating zone (10) and at a passage zone of the tubular body of the preforms, and comprising at least one second heating element (13) of said plurality of heating elements,
wherein the heating system (2) further comprises at least one first temperature sensor (8) arranged externally to the heating module (4) and at said first heating zone, and at least one second temperature sensor (9) arranged externally to the heating module (4) and at said at least one second heating zone.

### FIELD OF THE INVENTION

The present invention relates to a heating system for heating plastic material preforms, preferably to be arranged upstream of a blow molding or stretch-blow molding machine, the heating system being adapted to be crossed by a plurality of preforms advancing along a transport line. The invention also relates to a furnace comprising the aforesaid heating system, a blow molding plant for blowing containers comprising said furnace, and a related process for heating the preforms by means of said heating system.

### BACKGROUND ART

It is known that the blowing or stretch-blowing process must be preceded by a temperature conditioning step of the preforms, carried out in a furnace, in which the preforms are heated to a predefined temperature for the blowing by means of specific heating modules that use a plurality of heating elements, e.g. infrared lamps. The object of this heating of the preforms prior to the blow molding or stretch-blow molding step is to bring the material of the preform to an appropriate temperature to obtain a quality molded container.

Generally, the heating modules are arranged symmetrically in two benches, defining two tunnels connected by a curved stretch. The heating elements in each heating module are arranged along a plane substantially parallel to the plane containing the axes of the preforms advancing along the respective bench. The preforms, moved by a transfer chain provided with chucks, cross the heating modules of the two tunnels.

During the passage of the preforms in these heating modules, the neck of the preforms must remain substantially cold, i.e., at a temperature lower than the softening temperature so that the subsequent blowing operations do not deform it.

It is also known that the heating of the body of the preforms is achieved due to the combined effect of:
thermal radiation that penetrates into the thickness of the body of the preform (convection);
contact with the ambient air heated inside the furnace (conduction);
diffusion of the heat by conduction into the wall of the preform (stabilization/temperature inversion).

It also is important to ventilate the inside of the heating module and the outer surface of the preforms therein with a preset air flow so that the material of the outer surface of the preform is not brought to a too high temperature, which would cause it to crystalize while waiting for the material arranged inside the preform to reach the blowing temperature. This ventilation allows the ambient temperature of the heating module to be kept at a desirable level, eliminating the excessive heat, for example due to the infrared rays not captured by the preforms, and the temperature of the preform skin to be moderated. Such a desirable level of the inner temperature of the heating module is that one that allows the energy performance thereof to be optimized. It is well known that this energy performance is a function of the thickness of the preforms. The ventilation flow rate must be sufficient to absolve this function, and it is desirable for it to be well-distributed in the heating module so that the whole surface of the preform wall, which must be heated, is treated homogeneously.

Disadvantageously, the control of the temperature of the preforms immediately upstream of the molding machine is performed by means of a single temperature sensor mounted on the last heating module of the furnace. The possible feedback control, based on this single measuring point, for modulating the power of the heating elements of this last heating module leads to a non-optimal temperature profile on the whole preform, in particular, at the margins of the preform.

Therefore, the need is felt to provide a heating system capable of overcoming the stated drawback.

### SUMMARY OF THE INVENTION

It is an object of the present invention to provide a heating system for heating the preforms, upstream of a blow molding or stretch-blow molding machine or press, which allows better modulating the power of the heating elements thereof, resulting in an optimal temperature profile over the whole preform, in particular along each zone of the body of the preform.

It is another object of the present invention to provide a furnace comprising a plurality of heating systems, in which it is provided for at least one of said heating systems to be made according to the solution of the invention so as to allow the power of the heating elements thereof and/or the power of the heating elements of further heating systems, also of the known type, arranged upstream of the heating system of the invention, to be better modulated.

It is a further object of the present invention to provide a related preform heating process which uses the aforesaid heating system.

The present invention achieves such an object, and others that will be apparent in light of the present description, by means of a heating system for heating plastic material preforms upstream of a blow molding or stretch-blow molding machine, the system comprising a heating module adapted to be crossed by a plurality of preforms advancing along a transport line,
wherein the heating module is provided with a plurality of heating elements arranged along a plane substantially parallel to a plane containing the axes of the preforms adapted to cross said heating module,
wherein the heating module comprises
a first heating zone, proximal to a support area of the neck of the preforms and comprising at least one first heating element of said plurality of heating elements,
and at least one second heating zone, arranged adjacent to said first heating zone and at a passage zone of the tubular body of the preforms and comprising at least one second heating element of said plurality of heating elements,
wherein the system further comprises
at least one first temperature sensor arranged externally to the heating module and at said first heating zone,
and at least one second temperature sensor arranged externally to the heating module and at said at least one second heating zone,
wherein an electronic control device is provided, adapted to receive the temperature data detected both by said at least one first temperature sensor and said at least one second temperature sensor, compare said temperature data with predefined target temperatures of said first heating zone and said second heating zone, and act in feedback by regulating the power of said at least one first heating element and said at least one second heating element;
and wherein both said at least one first temperature sensor and said at least one second temperature sensor are arranged immediately downstream of the heating module.

The second heating zone, adjacent to the first heating zone, is arranged below the first heating zone in the case where the transport line is configured to advance the preforms with the opening of the neck facing upwards, or it is arranged above the first heating zone in the case where the transport line is configured to advance the preforms with the opening of the neck facing downwards.

Another aspect of the invention relates to a furnace for heating plastic material preforms adapted to be positioned upstream of a blow molding or stretch-blow molding machine, the furnace comprising a plurality of heating systems comprising a respective heating module adapted to be crossed by said plurality of preforms, and arranged in at least one bench,
wherein each heating module is provided with a plurality of respective heating elements arranged along a plane substantially parallel to the plane containing the axes of the preforms adapted to advance along the at least one bench,
wherein it is provided for at least one heating system of said heating systems to be made according to the solution of the invention,
and wherein the electronic control device of said at least one heating system of the invention is adapted to receive the temperature data detected both by the respective at least one first temperature sensor and the respective at least one second temperature sensor, compare said temperature data with predefined target temperatures of said first heating zone and said second heating zone of the respective heating module, and act in feedback by regulating the power of said at least one first heating element and said at least one second heating element of said respective heating module and/or act in feedback by regulating the power of the plurality of heating elements of one or more of the further heating systems of the furnace arranged upstream of said at least one heating system made according to the invention.

A further aspect of the invention relates to a blow molding plant for blow molding plastic material containers comprising in sequence
the aforesaid furnace,
and a blow molding or stretch-blow molding machine.

Finally, a last aspect of the present invention relates to a process for heating plastic material preforms by means of the heating system of the invention, wherein there are provided
a detection of the temperature of the preform at said first heating zone by means of said at least one first temperature sensor,
and a detection of the temperature of the preform at said at least one second heating zone by means of said at least one second temperature sensor,
and wherein the temperature data detected by both said at least one first temperature sensor and said at least one second temperature sensor are received by the electronic control device which compares them with predefined target temperatures of said first heating zone and said second heating zone to act in feedback by regulating the power of said at least one first heating element and said at least one second heating element.

Advantageously, the heating system of the invention has a high flexibility, allowing, based on the different shapes of the preform (for example, preforms with different thickness zones along the longitudinal axis thereof) or based on the length of the preform, the two or more heating zones, in which a determined heat gradient on the preform is desired, to be accurately controlled. This allows a desired constant distribution of the plastic on the container to be obtained while having thermal “disturbances” determined by the different temperature of the air and by the “edge” effect which can affect the thermal dynamics/thermal profile of the preform.

Further features and advantages of the invention will become more apparent in the light of the detailed description of exemplary, but non-exclusive embodiments thereof.

The dependent claims describe particular embodiments of the invention.

### BRIEF DESCRIPTION OF THE DRAWINGS

In the description of the invention, reference is made to the accompanying drawings, which are provided by way of non-limiting example, in which:

FIG. 1 shows a diagrammatic layout of a heating module bench of a furnace according to the invention;

FIG. 2 shows a diagrammatic sectional view of a first embodiment of a heating system according to the invention;

FIG. 3 shows a diagrammatic sectional view of a first variant of said first embodiment;
FIG. 4 shows a diagrammatic sectional view of a second variant of said first embodiment;

FIG. 5 shows a diagrammatic sectional view of a second embodiment of a heating system according to the invention;

FIG. 6 shows a diagrammatic sectional view of a first variant of said second embodiment;

FIG. 7 shows a diagrammatic sectional view of a second variant of said second embodiment;

FIG. 8 shows a diagrammatic layout of two heating module benches of a furnace according to the invention.

The same reference numerals and letters in the figures identify the same elements or components.

### DESCRIPTION OF EMBODIMENTS OF THE INVENTION

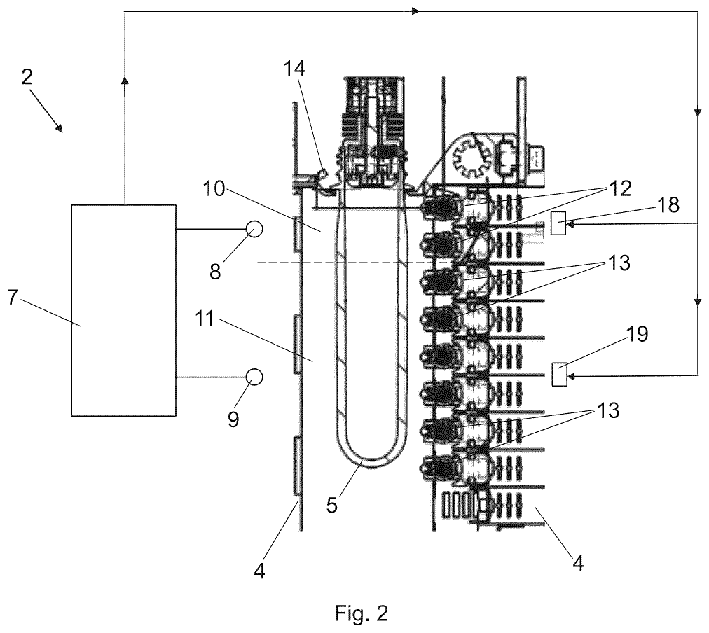

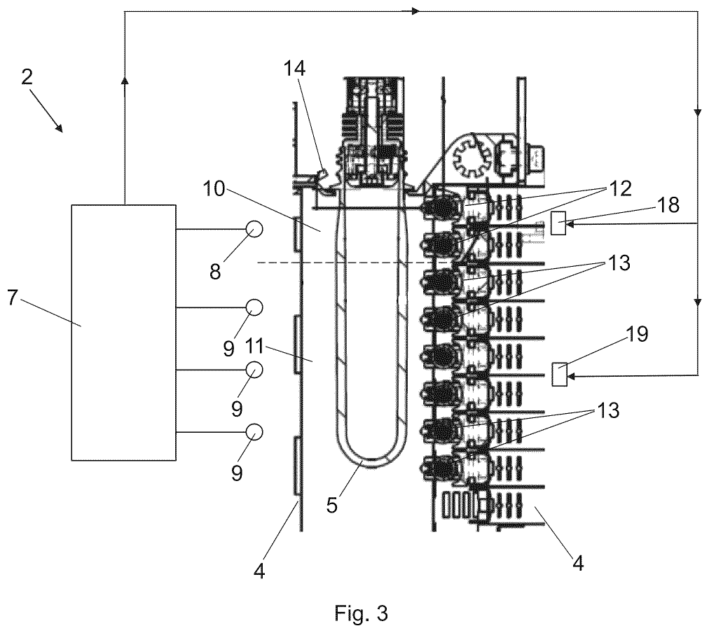

With reference to FIGS. 2-7, embodiments of a heating system 2 of the present invention for heating preforms 5, at the inlet of a blow molding or stretch-blow molding machine 3, are shown.

The preforms to be heated are made of plastic material, e.g., PET, PP, PLA, PVC, but the system of the invention can also be used to heat preforms made of different plastic material, or a combination of some of these materials.

In all embodiments of the invention, the heating system 2 comprises a heating module 4 adapted to be crossed by a plurality of preforms 5 advancing along a transport line 14.

Said heating module 4 is provided with a plurality of heating elements 12, 13 arranged along a plane substantially parallel to a plane containing the axes of the preforms 5 crossing the heating module.

In a first embodiment of the heating system of the invention, the heating module 4 comprises (FIGS. 2-4):
a first heating zone 10, proximal to a support area of the neck of the preforms, and comprising at least one first heating element 12,
and a second heating zone 11, for example, a single second heating zone, arranged below the first heating zone 10 and at a passage zone of the tubular body of the preforms, and comprising at least one second heating element 13.

In FIGS. 2-4, the transport line is configured to advance the preforms with the neck opening facing upwards. Alternatively, it is not excluded for the second heating zone 11 to be arranged above the first heating zone 10 if the transport line is configured to advance the preforms with the opening of the neck facing downwards.

In this first embodiment, the heating system 2 further comprises:
at least one first temperature sensor 8 arranged externally to the heating module 4 and at the first heating zone 10,
at least one second temperature sensor 9 arranged externally to the heating module 4 and at the second heating zone 11,
and an electronic control device 7 for receiving the temperature data detected both by said at least one first temperature sensor 8 and said at least one second temperature sensor 9, comparing said temperature data with predefined target temperatures of the first heating zone 10 and the second heating zone 11, and acting in feedback by regulating the power of said at least one first heating element 12 and said at least one second heating element 13.

In the variant in FIG. 2, the heating system 2 comprises:
only one first temperature sensor 8 at the first heating zone 10,
and only one second temperature sensor 9 at the second heating zone 11.

In this variant, the electronic control device 7 receives the temperature data detected by said first temperature sensor 8 and said second temperature sensor 9, compares said temperature data with predefined target temperatures of the first heating zone 10 and the second heating zone 11, and acts in feedback by regulating the power of the first heating elements 12 by means of the power regulator 18, and the power of the second heating elements 13 by means of the power regulator 19. Alternatively, one power regulator 18 can be provided for each heating element 12 and one power regulator 19 can be provided for each second heating element 13.

In the variant in FIG. 3, the heating system 2 comprises:
only one first temperature sensor 8 at the first heating zone 10,
and three second temperature sensors 9 at the second heating zone 11.

Alternatively, a single first temperature sensor 8 and two or more second temperature sensors 9 can be provided; or two or more first temperature sensors 8 and a single second temperature sensor 9; or two or more first temperature sensors 8 and two or more second temperature sensors 9.

In this variant, the electronic control device 7 receives the temperature data detected by the single first temperature sensor 8, or by the first temperature sensors 8, and by the second temperature sensors 9, or by the single temperature sensor 9, compares said temperature data with predefined target temperatures of the first heating zone 10 and the second heating zone 11, and acts in feedback by regulating the power of the first heating elements 12 by means of the power regulator 18, and the power of the second heating elements 13 by means of the power regulator 19. Alternatively, also in this case, one power regulator 18 can be provided for each heating element 12 and one power regulator 19 can be provided for each second heating element 13.

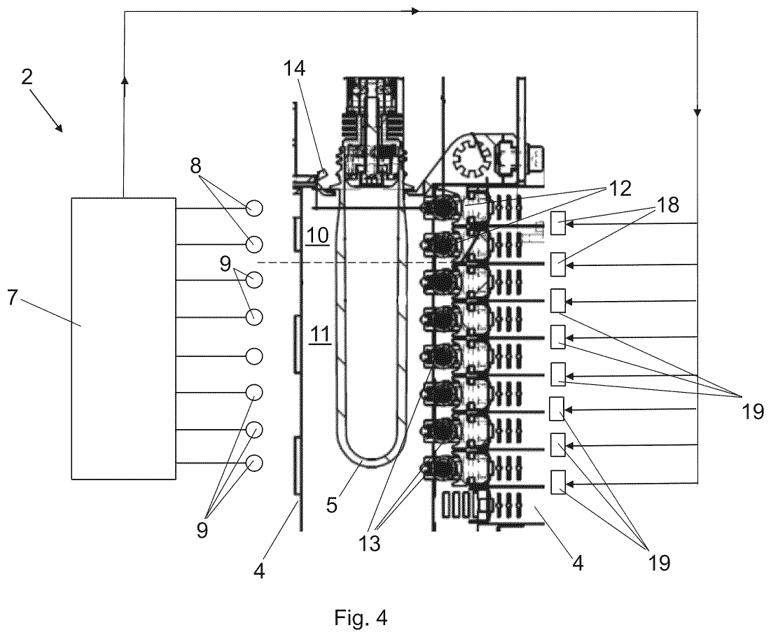

In the variant in FIG. 4, the heating system 2 comprises a respective first temperature sensor 8 for each first heating element 12 and a respective second temperature sensor 9 for each second heating element 13.

In this variant, the electronic control device 7 receives the temperature data detected by the first temperature sensors 8 and the second temperature sensors 9, compares said temperature data with predefined target temperatures of the first heating zone 10 and the second heating zone 11, and acts in feedback by regulating the power of the first heating elements 12 by means of the respective power regulators 18, and the power of the second heating elements 13 by means of the respective power regulators 19. Alternatively, a single power regulator can be provided for all the first heating elements 12 and a single power regulator 19 can be provided for all the second heating elements 13.

In all the variants in FIGS. 2-4, only by mere way of non-limiting example, the first heating zone 10, proximal to a support area of the neck of the preforms, comprises two heating elements 12; while the second heating zone 11, at a passage zone of the tubular body of the preforms, comprises six heating elements 13. It is possible for the heating elements 12 to be less than two or more than two, and for the heating elements 13 to be less than six or more than six.

Advantageously, the temperature sensors 8 and 9 are arranged immediately downstream of the heating module 4.

In particular, therefore, no components are provided between the outlet section of the heating module 4 and the temperature sensors.

For example, the temperature sensors 8, 9 are arranged also upstream of the transfer wheel (not shown), or of any other transfer means, which transfers the preforms from the heating module 4 to the blow molding or stretch-blow molding machine 3.

This configuration allows the feedback speed to be maximized while minimizing the feedback power regulating times of the heating elements 12, 13. Further, this configuration increases the quality of the measurement both with respect to solutions with temperature sensors integrated in a wall of the heating module and facing the inside of the module, with which a false temperature measurement is possible, and with respect to solutions with the temperature sensors arranged further downstream with respect to the heating module, in particular arranged further downstream of the last heating module, which result in a lengthening of the path of the preforms between the furnace and the molding machine and an increase in the transit time between the preform thermal conditioning and the container molding.

Further, the temperature sensors 8 and 9 face the outside of the heating module 4 to avoid the measurement from being taken on the preform during the exposure thereof to the radiation of the heating elements 12, 13.

This configuration allows any temperature sensor to be used, for example, any pyrometer or thermal camera, without the need to use particular materials which do not absorb radiations at the emission wavelengths of the heating elements.

Preferably, the outlet section of the heating module 4 is provided with a shield (not shown) to avoid the presence of residual thermal radiations of the heating module from altering the measurement of the temperature and accordingly, causing errors in setting the heating profile.

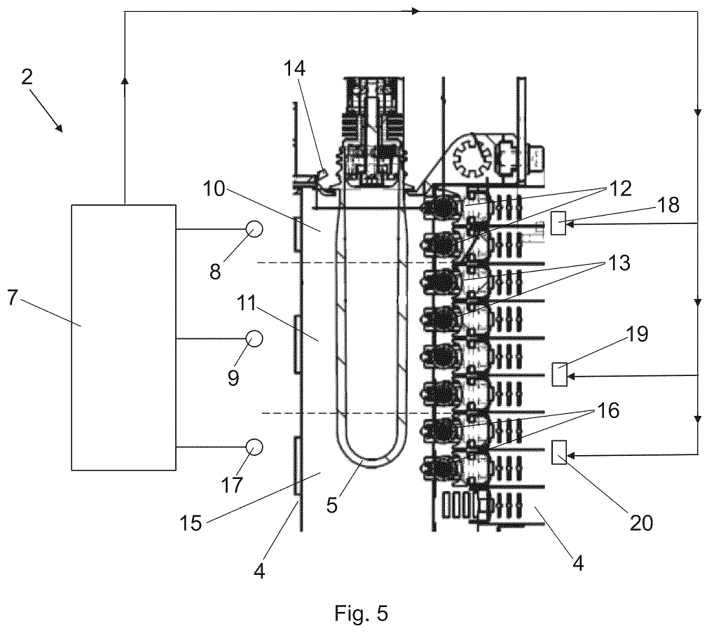

In a second embodiment of the heating system of the invention, the heating module 4 comprises (FIGS. 5-7):
a first heating zone 10, proximal to a support area of the neck of the preforms, and comprising at least one first heating element 12,
a second heating zone 11, arranged below the first heating zone 10 and at a passage zone of the tubular body of the preforms, and comprising at least one second heating element 13;
and a third heating zone 15, arranged below said second heating zone 11 and at a passage zone of the bottom of the preforms, and comprising at least one third heating element 16.

In FIGS. 5-7, the transport line is configured to advance the preforms with the opening of the neck facing upwards. Alternatively, it is not excluded for the second heating zone 11 to be arranged above the first heating zone 10 and the third heating zone 15 to be arranged above said second heating zone 11 if the transport line is configured to advance the preforms with the opening of the neck facing downwards.

In this second embodiment, the heating system 2 further comprises:
at least one first temperature sensor 8 arranged externally to the heating module 4 and at the first heating zone 10,
at least one second temperature sensor 9 arranged externally to the heating module 4 and at the second heating zone 11,
at least one third temperature sensor 17 arranged externally to the heating module 4 and at the third heating zone 15,
and an electronic control device 7 for receiving the temperature data detected by said at least one first temperature sensor 8, said at least one second temperature sensor 9, and said at least one third temperature sensor 17, comparing said temperature data with predefined target temperatures of the first heating zone 10, second heating zone 11, and third heating zone, respectively, and acting in feedback by regulating the power of said at least one first heating element 12, said at least one second heating element 13, and said at least one third heating element 16.

In the variant in FIG. 5, the heating system 2 comprises:
only one first temperature sensor 8 at the first heating zone 10,
only one second temperature sensor 9 at the second heating zone 11,
and only one third temperature sensor 17 at the third heating zone 15.

In this variant, the electronic control device 7 receives the temperature data detected by said first temperature sensor 8, said second temperature sensor 9, and said third temperature sensor 17, it compares them with predefined target temperatures of the first heating zone 10, second heating zone 11, and third heating zone 15, respectively, and acts in feedback by regulating the power of the first heating elements 12 by means of the power regulator 18, the power of the second heating elements 13 by means of the power regulator 19, and the power of the third heating elements 16 by means of the power regulator 20. Alternatively, one power regulator 18 for each heating element 12, one power regulator 19 for each second heating element 13, and one power regulator 20 for each third heating element 16 can be provided.

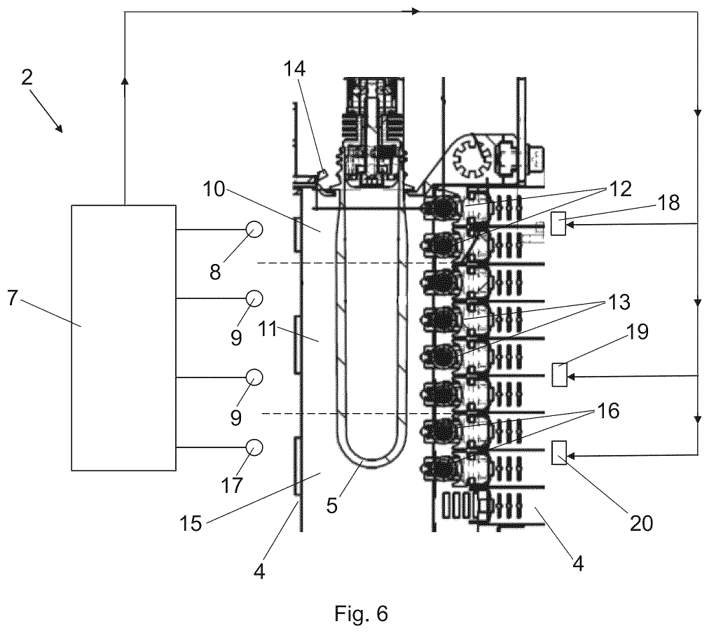

In the variant in FIG. 6, the heating system 2 comprises:
only one first temperature sensor 8 at the first heating zone 10,
two second temperature sensors 9 at the second heating zone 11,
and only one third temperature sensor 17 at the third heating zone 15.

Alternatively, there can be provided
only one first temperature sensor 8, three or more second temperature sensors 9, and only one third temperature sensor 17;
or two or more first temperature sensors 8, only one second temperature sensor 9, and only one third temperature sensor 17;
or only one first temperature sensor 8, only one second temperature sensor 9, and two or more third temperature sensors 17;
or two or more first temperature sensors 8, two or more second temperature sensors 9, and only one third temperature sensor 17;
or two or more first temperature sensors 8, only one second temperature sensor 9, and two or more third temperature sensors 17;
or only one first temperature sensor 8, two or more second temperature sensors 9, and two or more third temperature sensors 17;
or two or more first temperature sensors 8, two or more second temperature sensors 9, and two or more third temperature sensors 17.

In this variant, the electronic control device 7 receives the temperature data detected by the single first temperature sensor 8, or by the first temperature sensors 8, by the second temperature sensors 9, or by the single temperature sensor 9, and by the third temperature sensors 17, or by the single temperature sensor 17, compares said temperature data with predefined target temperatures of the first heating zone 10, the second heating zone 11, and the third heating zone 15, respectively, and acts in feedback by regulating the power of the first heating elements 12 by means of the power regulator 18, the power of the second heating elements 13 by means of the power regulator 19, and the power of the third heating elements 16 by means of the power regulator 20. Alternatively, one power regulator 18 for each heating element 12, one power regulator 19 for each second heating element 13, and one power regulator 20 for each third heating element 16 can be provided.

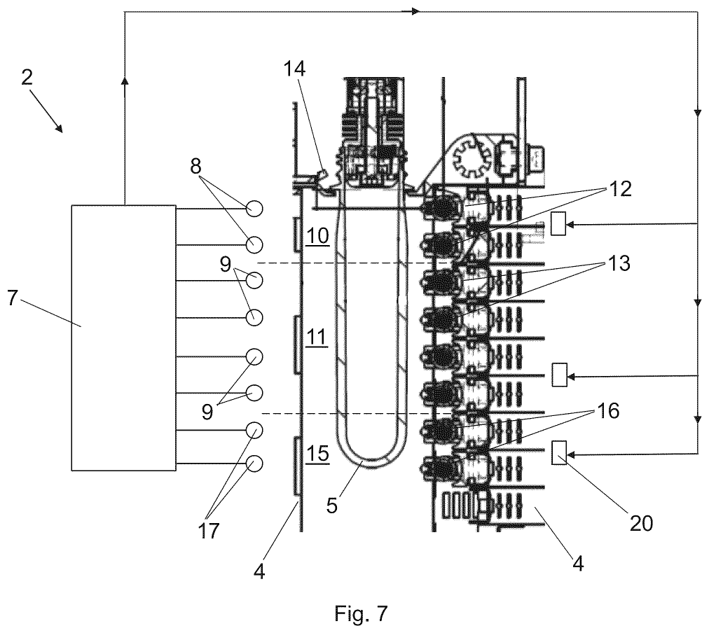

In the variant in FIG. 7, the heating system 2 comprises a respective first temperature sensor 8 for each first heating element 12, a respective second temperature sensor 9 for each second heating element 13, and a respective third temperature sensor 17 for each third heating element 16.

In this variant, the electronic control device 7 receives the temperature data detected by the first temperature sensors 8, second temperature sensors 9, and third temperature sensors 17, compares said temperature data with predefined target temperatures of the first heating zone 10, second heating zone 11, and third heating zone 15, respectively, and acts in feedback by regulating the power of the first heating elements 12 by means of respective power regulators 18, the power of the second heating elements 13 by means of respective power regulators 19, and the power of the third heating elements 16 by means of respective power regulators 20. Alternatively, as shown in FIG. 7, a single power regulator can be provided for all the first heating elements 12, a single power regulator 19 can be provided for all the second heating elements 13, and a single power regulator 20 can be provided for all the third heating elements 16.

In all the variants in FIGS. 5-7, only by mere way of non-limiting example, the first heating zone 10, proximal to a support area of the neck of the preforms, comprises two heating elements 12; the second heating zone 11, at a passage zone of the tubular body of the preforms, comprises four heating elements 13; and the third heating zone 15, at a passage zone of the bottom of the preforms, comprises two third heating elements 16. It is possible for the heating elements 12 to be less than two or more than two, the heating elements 13 to be less than four or more than four, and the heating elements 16 to be less than two or more than two.

Advantageously, as in the first embodiment of the invention, the temperature sensors 8, 9 and 17 are arranged immediately downstream of the heating module 4.

In particular, therefore, no components are provided between the outlet section of the heating module 4 and the temperature sensors.

For example, the temperature sensors 8, 9, 17 are arranged also upstream of the transfer wheel, or of any other transfer means, which transfers the preforms from the heating module 4 to the blow molding or stretch-blow molding machine 3.

Further, the temperature sensors 8, 9 and 17 face the outside of the heating module 4 to avoid the measurement from being taken on the preform during the exposure thereof to the radiation of the heating elements 12, 13 and 16. Preferably, the outlet section of the heating module 4 is provided with a shield (not shown) to avoid the presence of residual thermal radiations of the heating module from altering the measurement of the temperature and, accordingly, causing errors in setting the heating profile.

In all the embodiments of the invention, the heating elements 12, 13, 16 can be infrared lamps arranged along a first plane substantially parallel to said plane containing the axes of the preforms adapted to cross said heating module. Alternatively to the infrared lamps, LED lamps or laser lamps or NIR lamps can be used, or other suitable heating element. Similarly, the temperature sensors 8, 9 17 are arranged along a second plane substantially parallel to the plane containing the axes of the preforms, adapted to cross said heating module, and to said first plane along which the heating elements 12, 13, 16 are arranged.

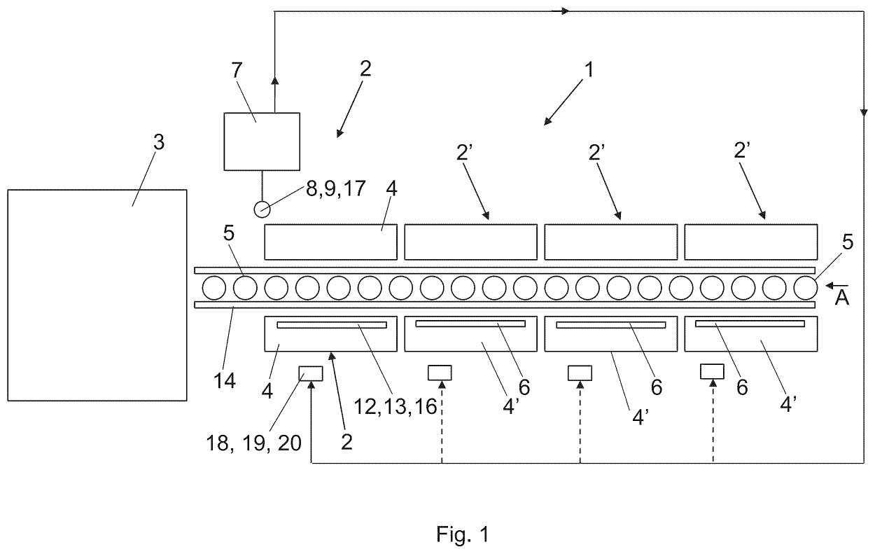

A further aspect of the present invention relates to a furnace 1 for heating plastic material preforms, diagrammatically shown in FIG. 1, arranged upstream of a blow molding or stretch-blow molding machine 3.

Such a furnace 1 comprises a plurality of heating systems 2, 2′comprising a respective heating module 4, 4′, adapted to be crossed by the preforms 5 advancing along a transport line 14, and arranged in at least one bench.

At least one heating system, indicated by reference numeral 2, is made according to the invention, according to one of the variants described above.

The remaining heating systems are of the conventional type, indicated by reference numeral 2′. Each heating module 4′is provided with a plurality of heating elements 6 arranged along a plane substantially parallel to the plane containing the axes of the preforms 5 advancing along the bench.

Such heating modules 4′can be made according to any one of the solutions known from the prior art.

Advantageously, the electronic control device 7 of the at least one heating system 2 according to the invention is adapted to
receive the temperature data detected by both the respective at least one first temperature sensor 8 and the respective at least one second temperature sensor 9, and possibly also by the at least one third temperature sensor 17;
compare said temperature data with predefined target temperatures of said first heating zone 10 and said second heating zone 11, and possibly also of said third heating zone 15, of the respective heating module 4,
and act in feedback by regulating the power of said at least one first heating element 12 and said at least one second heating element 13, and possibly also said at least one third heating element 16, of said respective heating module 4 and/or act in feedback by regulating the power of the plurality of heating elements 6 of the remaining heating systems 2′of furnace 1 arranged upstream of said at least one heating system 2 according to the invention.

The example in FIG. 1 shows a furnace 1 with a single linear bench of heating systems 2, 2′. Arrow A indicates the advancement direction of the preforms 5 crossing the respective heating modules 4, 4′.

In this non-limiting example, the heating system 2 according to the invention is the last system of the bench, placed immediately upstream of the molding machine 3, which can be a linear type machine or a rotating machine.

Alternatively, the heating system 2 according to the invention can be arranged in an intermediate position within the bench.

In a configuration (not shown) of a furnace with two benches connected by a connection stretch, for example a curved or serpentine stretch, a heating system according to the invention can be arranged immediately upstream of the stretch-blow molding machine 3 and immediately downstream of the second bench of heating systems, and/or in an intermediate position into the second bench, and/or in an intermediate position into the first bench.

For increased control of the temperature of the preforms along the transport line, a first detecting device for detecting the temperature of the preform can be arranged at the inlet of the first bench, and a second detecting device for detecting the temperature of the preform can be arranged at said connection segment.

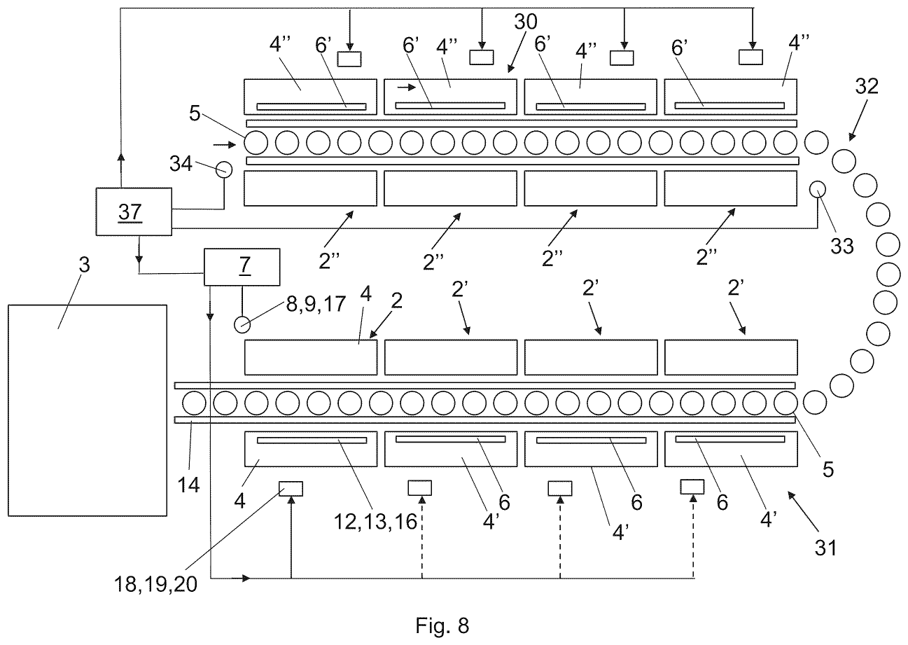

More in detail, as shown diagrammatically in FIG. 8, the furnace 1 is provided with two benches 30, 31 connected by a connection stretch 32.

The second bench 31, proximal to the blow molding or stretch-blow molding machine 3, comprises a plurality of heating systems 2, 2′comprising a respective heating module 4, 4′, adapted to be crossed by the preforms 5 advancing along the transport line 14.

At least one heating system, indicated by reference numeral 2, is made according to the invention, according to one of the variants described above.

The remaining heating systems are of the conventional type, indicated by reference numeral 2′. Each heating module 4′is provided with a plurality of heating elements 6 arranged along a plane substantially parallel to the plane containing the axes of the preforms 5 advancing along the second bench 31.

Such heating modules 4′can be made according to any one of the solutions known from the prior art.

Preferably, the heating system 2 according to the invention is the last system of the second bench 31, the closest to the molding machine 3.

The first bench 30, distal from the blow molding or stretch-blow molding machine 3, comprises a plurality of heating systems 2″ comprising a respective heating module 4″, of conventional type.

Each heating module 4″ is provided with a plurality of heating elements 6′arranged along a plane substantially parallel to the plane containing the axes of the preforms 5 advancing along the first bench 30.

Such heating modules 4″ can be made according to any one of the solutions known from the prior art.

Advantageously, at least one temperature sensor 33, preferably a single temperature sensor 33, is arranged at said connection stretch 32, preferably immediately downstream of the first bench 30.

A further electronic control device 37 is adapted to receive the temperature data detected by said at least one temperature sensor 33, compare said temperature data with a predefined target temperature of the preform at the outlet of the first bench 30, and act in feedback by regulating the power of the heating elements 6′of the heating modules 4″ by means of respective power regulators.

Preferably, at least one further temperature sensor 34, optionally a single further temperature sensor 34, is arranged at the inlet of the first bench 30.

Said further electronic control device 37 is adapted also to receive the temperature data detected by said at least one further temperature sensor 34, compare said temperature data with a predefined target temperature of the preform at the inlet of the first bench 30, to optimize the power of the heating elements 6′of the heating modules 4″ before the preform crosses it.

In a preferred variant, said further electronic control device 37 cooperates with the electronic control device 7, sending to the latter the temperature data detected by said at least one temperature sensor 33 to optimize the power of the heating elements 12, 13, 16 and 6 of the heating modules 4, 4′of the second bench 31 before the preform crosses said heating modules.

A further aspect of the invention relates to a process for heating plastic material preforms by means of a heating system according to the invention, wherein the following is provided
a detection of the temperature of the preform at said first heating zone 10 by means of said at least one first temperature sensor 8,
a detection of the temperature of the preform at said at least one second heating zone 11 by means of said at least one second temperature sensor 9,
and a possible detection of the temperature of the preform at said at least one third heating zone 15 by means of said at least one third temperature sensor 17,
and wherein the temperature data detected both by said at least one first temperature sensor 8 and said at least one second temperature sensor 9, and possibly also by said at least one third temperature sensor 17, are received by the electronic control device 7 that compares them with predefined target temperatures of said first heating zone 10 and said second heating zone11, and of the possible third heating zone 15, to act in feedback by regulating the power of said at least one first heating element 12 and said at least one second heating element 13, and possibly of said at least one third heating element 16.

A further aspect of the invention relates to a process for heating plastic material preforms by means of the furnace diagrammatically shown in FIG. 8, wherein there is further provided a detection of the temperature of the preform at the connection stretch 32, preferably immediately downstream of the first bench 30, by means of said at least one temperature sensor 33; and wherein the temperature data detected by said at least one temperature sensor 33 are received by the further electronic control device 37 which compares said temperature data with one predefined target temperature of the preform surface at the outlet of the first bench 30 to act in feedback by regulating the power of the heating elements 6′of one or more heating modules 4″ by means of special power regulators.

Preferably, said further electronic control device 37 cooperates with the electronic control device 7 by sending to the latter the temperature data detected by said at least one temperature sensor 33 so that said electronic control device 7 optimizes, in the second bench 31, the power of the heating element 12, 13 and 16 of the respective heating module 4 of the heating system 2 and/or the power of the plurality of heating elements 6 of one or more of the further heating systems 2′.

Finally, a preferred option is detecting the temperature of the surface of the preform at the inlet of the first bench 30 by means of said at least one further temperature sensor 34.

In this case, the temperature data detected by said at least one further temperature sensor 34 are received by the further electronic control device 37 which compares said temperature data with a predefined target temperature of the surface of the preform at the inlet of the first bench 30 to optimize the power of the heating elements 6′of the heating modules 4″.

1. A heating system for heating plastic material preforms upstream of a blow molding or stretch-blow molding machine, the heating system comprising a heating module adapted to be crossed by a plurality of preforms advancing along a transport line,
wherein the heating module is provided with a plurality of heating elements arranged along a first plane substantially parallel to a second plane containing axes of the preforms adapted to cross said heating module,
wherein the heating module comprises
a first heating zone, proximal to a support area of a neck of the preforms, and comprising at least one first heating element of said plurality of heating elements,
and at least one second heating zone, arranged adjacent to said first heating zone and at a passage zone of a tubular body of the preforms, and comprising at least one second heating element of said plurality of heating elements,
wherein the heating system further comprises
at least one first temperature sensor arranged externally to the heating module and at said first heating zone,
and at least one second temperature sensor arranged externally to the heating module and at said at least one second heating zone,
wherein an electronic control device is provided, adapted to receive temperature data detected both by said at least one first temperature sensor and said at least one second temperature sensor compare said temperature data with predefined target temperatures of said first heating zone and said at least one second heating zone and act in feedback by regulating a power of said at least one first heating element and said at least one second heating element;
and wherein both said at least one first temperature sensor and said at least one second temperature sensor are arranged immediately downstream of the heating module and are facing an outside of said heating module.

2. The system according to claim 1, wherein there are provided a first temperature sensor for each first heating element and a second temperature sensor for each second heating element.

3. The system according to claim 1, further comprising
at least one third heating zone, arranged adjacent to said at least one second heating zone and at a passage zone of a bottom of the preforms, and comprising at least one third heating element of said plurality of heating elements;
and at least one third temperature sensor arranged externally to the heating module and at said at least one third heating zone,
and wherein said electronic control device is adapted to also receive the temperature data detected by said at least one third temperature sensor, compare them with at least one predefined target temperature of said at least one third heating zone, and act in feedback by regulating the power of said at least one third heating element.

4. The system according to claim 3, wherein there are provided a first temperature sensor for each first heating element a second temperature sensor for each second heating element, and a third temperature sensor for each third heating element.

5. The system according to claim 1, wherein said plurality of heating elements comprises infrared lamps or NIR lamps or laser lamps, arranged along the first plane substantially parallel to said second plane containing the axes of the preforms adapted to cross said heating module.

6. The system according to claim 3, wherein said at least one third temperature sensor is arranged immediately downstream of the heating module, and preferably facing the outside of said heating module.

7. A furnace for heating plastic material preforms, adapted to be positioned upstream of a blow molding or stretch-blow molding machine, the furnace comprising a plurality of heating systems comprising a respective heating module, adapted to be crossed by said plurality of preforms, and arranged in at least one bench,
wherein each heating module is provided with a plurality of respective heating elements arranged along a first plane substantially parallel to a second plane containing axes of the preforms adapted to advance along the at least one bench,
wherein it is provided for at least one heating system of said heating systems to be made according to claim 1,
and wherein the electronic control device of said at least one heating system is adapted to
receive the temperature data detected by both the respective at least one first temperature sensor and the respective at least one second temperature sensor, compare said temperature data with predefined target temperatures of said first heating zone and said at least one second heating zone of the respective heating module,
and act in feedback by regulating the power of said at least one first heating element and said at least one second heating element of said respective heating module and/or act in feedback by regulating the power of the plurality of heating elements of one or more of further heating systems of the furnace arranged upstream of said at least one heating system made according to claim 1.

8. The furnace according to claim 7, wherein said plurality of heating systems, comprising a respective heating module, is arranged in a bench;
wherein there is provided a further bench arranged upstream of the bench and provided with a plurality of respective heating systems, comprising a respective heating module, and connected to said bench by means of a connection stretch;
wherein each heating module of the heating systems of said further bench is provided with a plurality of respective heating elements arranged along a plane substantially parallel to the plane containing the axes of the preforms advancing along said further bench;
wherein at least one further first temperature sensor, preferably a single further first temperature sensor is arranged at said connection stretch, preferably immediately downstream of the further bench;
and wherein a further electronic control device is adapted to receive the temperature data detected by said at least one further first temperature sensor, compare said temperature data with a predefined target temperature of the surface of the preform at the outlet of said further bench, and act in feedback by regulating the power of the heating elements of one or more of the heating modules of the heating systems of said further bench.

9. The furnace according to claim 8, wherein said further electronic control device is adapted to cooperate with the electronic control device by sending to this latter the temperature data detected by said at least one further first temperature sensor, so that said electronic control device can optimize the power of said at least one first heating element and said at least one second heating element of said respective heating module and/or the power of the plurality of the heating elements of one or more of the further heating systems of said bench.

10. The furnace according to claim 8, wherein there is provided at least one further second temperature sensor, preferably a single further second temperature sensor, arranged at the inlet of the further bench;
and wherein said further electronic control device is also adapted to receive the temperature data detected by said at least one further second temperature sensor, and compare them with a predefined target temperature of the surface of the preform at the inlet of the further bench to optimize the power of the heating elements of the heating modules in the heating systems of said further bench.

11. A blow molding plant for blow molding plastic material containers comprising in sequence
a furnace (1) according to claim 7,
and a blow molding or stretch-blow molding machine.

12. A process for heating plastic material preforms by means of a heating system according to claim 1, wherein the following steps are provided
a detection of the temperature of the preform at said first heating zone by means of said at least one first temperature sensor,
and a detection of the temperature of the preform at said at least one second heating zone by means of said at least one second temperature sensor,
and wherein the temperature data detected by both said at least one first temperature sensor and said at least one second temperature sensor are received by the electronic control device which compares them with predefined target temperatures of said first heating zone and said at least one second heating zone to act in feedback by regulating the power of said at least one first heating element and said at least one second heating element.
